(19) United States
(12) Patent Application Publication
(10) Pub. No.: US 2026/0115760 A1
(43) Pub. Date: Apr. 30, 2026

(54) METHOD FOR STRUCTURING A SURFACE BY DIRECTLY APPLYING A TREATMENT MEDIUM, AND EDGE STRIP HAVING SURFACE STRUCTURING

(71) Applicant: Fritz Egger GmbH & Co. OG, St. Johann, Tirol (AT)

(72) Inventors: Thomas Streichardt, Warendorf (DE); Peter Florian Schwermer, Kirchhundem (DE)

(21) Appl. No.: 19/168,773

(22) PCT Filed: Mar. 21, 2024
(86) PCT No.: PCT/EP2024/057533

§ 371 Date: Sep. 24, 2025

(30) Foreign Application Priority Data
Mar. 31, 2023 (EP) 23165854.3

(51) Int. Cl. B05D 7/02; B05D 1/00

(52) U.S. Cl. CPC B05D 7/02; B05D 1/002; B05D 2201/02

(57) ABSTRACT

The invention relates to a method for treating a surface, in which: a substrate is provided with a surface, the surface at least partly comprising a polymer material, the polymer material containing a thermoplastic and/or a thermoplastic elastomer, and the polymer material on the surface of the substrate being at least partly in a molten state; a liquid treatment medium is provided in the form of droplets; and the liquid treatment medium is accelerated towards the surface of the substrate. The method is characterised in that the surface of the substrate is applied with the liquid treatment medium before the polymer material has completely solidified, preferably before the solidification process of the polymer material has started, so that surface structuring is produced on the surface of the substrate. The invention also relates to an edge strip having surface structuring which is produced by the method.

### CROSS-REFERENCE TO RELATED APPLICATIONS

The present application claims priority to PCT International Patent Application No. PCT/EP2024/057533, filed Mar. 21, 2024, and European Patent Application No. 23165854.3, filed on Mar. 31, 2023, the disclosures of which are incorporated herein by reference.

### STATEMENT RE: FEDERALLY SPONSORED RESEARCH/DEVELOPMENT

Not Applicable

### BACKGROUND

The present invention relates to a method for treating a surface, in which a substrate with a surface is provided, wherein the surface at least partially comprises a polymer material, wherein the polymer material contains a thermoplastic and/or a thermoplastic elastomer, wherein the polymer material on the surface of the substrate is at least partly in a molten state, in which a liquid treatment medium is provided in the form of droplets, and in which the liquid treatment medium is accelerated towards the surface of the substrate. The present disclosure further relates to an edge strip having a base body and having at least one layer close to the surface, wherein the at least one layer close to the surface is formed at least partially from a polymer material, wherein the polymer material contains a thermoplastic and/or a thermoplastic elastomer, and wherein the surface has a surface structuring.

From the prior art, and particularly in the field of furniture and laminate flooring production, it is known to provide surfaces with a structure by an embossing method. Traditionally, a structure generator such as an embossing roller with a three-dimensional surface structure is used, which corresponds to a negative image of the structural pattern to be applied. The embossing roller can be heated to assist embossing into the surface to be prepared. Alternatively or additionally, the surface to be prepared can be hardened before or after the embossing method. In addition, the use of structure generators in the form of structure generator sheets, strips or foils is also known. This means that a desired structural pattern is pressed into the surface during surface preparation, just as when using an embossing roller with a three-dimensional surface structure.

For both known structuring methods, an element is accordingly used that bears the pattern or is provided with the pattern or has a three-dimensional surface structure corresponding to the pattern. The production of such a structured structure generator is complex and costly. In addition, a production time of 4 to 6 months is generally to be expected for a structured embossing roller, which then results in long delivery times for the production of the final products such as laminate flooring or furniture.

In addition, a structuring method using a structured element presents complex challenges such as the precise adjustment of the embossing roller or the press for pressing the structure generator into the surface to be prepared for a specific structural depth of the pattern. The removal of the structure generator texture can also be problematic since this can lead to stretchings or distortions of the pattern on the surface being prepared. In addition, less prominent structures or patterns are often preferred in order to make repetitions of the so-called repeat or maximum length of the pattern, which is limited by the circumference of the embossing roller, appear less conspicuous. For example, in this regard, a repeat or a repetition of the pattern on the surface to be prepared in a magnitude of approximately 50 cm is conceivable.

Digital printing has improved the preparation of surfaces with patterns, for example, by patterns no longer being limited by the circumference of an embossing roller or by allowing application of a pattern or decoration with an endless length. Nevertheless, providing a structure to a surface to be prepared, i.e. a three-dimensional pattern, remains problematic. To achieve surface structuring, the substrate can be prepared in separate method steps, first by embossing in order to create a specific embossed pattern on the surface, then by digital printing to apply an image to the embossed surface. However, the coordination of such method steps is challenging, and often a surface is obtained with an embossment and an image that do not match each other optimally.

DE 10 2015 110 236 B4 discloses a method and a device for producing a structure on a surface of a flat workpiece. Here, in a first step, a workpiece is coated with a liquid base layer in the form of an acrylic paint, and in a second step, liquid droplets are sprayed thereon. In a third step, the liquid base layer and the sprayed-on liquid droplets are dried together. DE 10 2015 110 236 B4 therefore discloses a dispersion that is modified and not a polymer melt.

In particular, there are also hurdles in the provision of a new embossing roller, not only from the aspect of structuring the embossing roller surface itself but also from the aspect of installing the new embossing roller in the production line with a crane and the precise adjustment of the embossing parameters such as penetration depth, etc.

Against this background, the object of the present invention is based on improving known methods for treating a surface and, in particular, on providing a method which simultaneously offers increased flexibility in the production of edge strips and an optimal surface structuring quality.

### BRIEF SUMMARY

The aforementioned object is achieved according to the invention by a method for treating a surface, in which a substrate is provided with a surface, wherein the surface at least partially comprises a polymer material, wherein the polymer material contains a thermoplastic and/or a thermoplastic elastomer, and wherein the polymer material on the surface of the substrate is at least partially in a molten state, in which a liquid treatment medium is provided in the form of droplets, in which the liquid treatment medium is accelerated towards the surface of the substrate, characterized in that the surface of the substrate is exposed to the liquid treatment medium before the polymer material has completely solidified, preferably before the solidification process of the polymer material has started, so that a surface structuring is produced on the surface of the substrate.

Also disclosed is an edge strip with a base body and with at least one layer close to the surface, wherein the at least one layer close to the surface is formed at least partially from a polymer material, wherein the polymer material contains a thermoplastic and/or a thermoplastic elastomer, and wherein the layer close to the surface has a surface structuring, characterized in that the surface structuring has been produced by a method according to the present invention.

Due to the liquid treatment medium a great flexibility in use is achieved, wherein at the same time, high-quality structuring on a surface can be achieved. By the direct application to the substrate surface without the use of an intermediate medium, e.g. a carrier medium, the time-consuming and complex provision or installation of an embossing roller can be dispensed with, and the problem of pattern or structuring repetition can be avoided. Furthermore, the method can be carried out following a manufacturing method for the substrate in a simple, cost-effective and space-saving manner in comparison to an embossing method by means of an embossing roller. In addition, a wide variety of surface structuring types can be achieved by selecting the composition, the temperature and other properties of the treatment medium.

Furthermore, by applying droplets to the substrate surface, a spatial pattern can be easily reproduced using already available means, wherein particularly fine structures can be created. In particular, the liquid treatment medium can thus be applied to the surface with high precision so that the overall quality and reliability of the method result are increased overall.

In the context of the present invention, the term “substrate” is understood as a carrier or body that has at least one surface. The substrate can be single-piece or multi-piece, have a layered structure with layers that have different material compositions, have a sandwich structure, or be a solid component. In particular, the substrate can be a film, an intermediate product or component for the production of furniture, flooring, automobiles, windows or similar. The substrate can be provided by injection molding, extrusion, rolling, pressing, calendering, wherein these processes can be carried out individually or in combination. For example, a polymer material can be provided by means of an extruder before being fed into a mold by injection. Furthermore, the substrate can be provided by means of several manufacturing steps that take place one after the other. An example of this is a substrate that is first provided by extrusion and then by means of rolling or calendering.

The substrate can be provided as an extrudate by being produced by extrusion, in particular by co-extrusion or by post-co-extrusion. Co-extrusion can be understood as the simultaneous extrusion of at least two polymer materials through a single nozzle. This results in a single extruded product having a plurality of layers of different compositions and that are bonded together. In post-co-extrusion, the at least two polymer materials can be brought together with a time delay to form the substrate. For example, first a base body can thus be produced by a first extruder, and then a surface layer can be applied to the base body by means of a further extruder downstream of the first extruder. The base body can thus be at least partially solidified when the surface layer is applied as a melt stream.

The surface of the substrate comprises at least one polymer material. A polymer material for the purposes of the present invention is a chemical substance that consists of macromolecules. In this case, the macromolecules have one or more structural units or repeating units that are the same or different. A polymer material can be natural, i.e. produced by living organisms, or synthetic. The term polymer material includes, among other things, thermoplastics, elastomers, thermosets and thermoplastic elastomers.

In the present case, the polymer material contains a thermoplastic and/or a thermoplastic elastomer. In this regard, thermoplastics, also called plastomers, can be in particular plastics that can be deformed within a certain temperature range. This process is reversible, meaning it can be repeated as often as required by cooling and reheating to the molten state as long as so-called thermal decomposition of the material does not occur due to overheating. This is where thermoplastics differ from thermosets and elastomers. Another unique selling point is the weldability of thermoplastics.

A thermoplastic elastomer should be understood as a material that becomes thermoplastic and thus flowable when heat is supplied. The material can be elastic at the usual ambient temperature, especially at room temperature. In particular, the elastic properties of the polymer material arise from the simultaneous presence of physical crystalline or semi-crystalline and elastic regions in the material mass at the working temperature. Thermoplastic elastomers are, for example, block copolymers which include thermoplastic styrene elastomers (TPS), thermoplastic urethane elastomers (TPU), thermoplastic polyamide elastomers (TPA), and thermoplastic copolyester elastomers (TPC). Elastomer alloys (so-called “blends”) such as thermoplastic olefin elastomers (TPO) and thermoplastic vulcanizates (TPV) also belong to the thermoplastic elastomers.

Various thermoplastics and/or thermoplastic elastomers can be used for the polymer material. The polymer material is expediently selected according to the desired properties of the surface of the substrate, in particular of the film or the edge strip. Preferably, the polymer material is selected from the group consisting of polyethylene, polypropylene, acrylonitrile-butadiene-styrene copolymer, polyvinyl chloride, polymethyl methacrylate, polyethylene terephthalate, polylactic acid, thermoplastic styrene elastomers (TPS), thermoplastic urethane elastomers (TPU), thermoplastic polyamide elastomers (TPA), thermoplastic copolyester elastomers (TPC), thermoplastic olefin elastomers (TPO), thermoplastic vulcanizates (TPV), and mixtures thereof. More preferably, the polymer material is selected from the group consisting of polyethylene, polypropylene, acrylonitrile-butadiene-styrene copolymer, polyvinyl chloride, polymethyl methacrylate, polyethylene terephthalate and mixtures thereof.

The substrate is provided with a surface, wherein the polymer material at the surface of the substrate is at least partially in a molten state. The molten state is preferably caused by a melting process and corresponds to a liquid or viscous aggregate state of the polymer material on the surface of the substrate, wherein in the context of the invention, the term “molten state” comprises aggregate states of the polymer material in which the polymer material is not completely solidified or crystallized. The polymer material on the surface of the substrate which is in a molten state preferably has a temperature which exceeds the melting temperature of the polymer material, in particular a temperature which exceeds the melting temperature of the polymer material by at least 15° C., preferably by at least 20° C., more preferably by at least 25° C., even more preferably by at least 30° C., in particular by an amount in the range of 20 to 30° C.

During a melting process, the polymer material on the surface of the substrate is exposed to temperature and pressure conditions that lead to a phase transition of the polymer material from a solid state into a liquid or viscous state. In particular, during a melting process, the melting temperature or glass transition temperature is exceeded at the pressure then prevailing.

The surface of the substrate is exposed to the liquid treatment medium before complete solidification of the polymer material, preferably before the solidification process of the polymer material begins. Alternatively or additionally, the polymer material can be exposed to the liquid treatment medium in a liquid aggregate state, in a partially liquid aggregate state and/or in a partially solidified aggregate state. In particular, the application of the liquid treatment medium to the surface can at least partially initiate solidification of the polymer material at the surface, advantageously where the liquid treatment medium comes into contact with the surface of the substrate. Solidification can be caused, for example, by the treatment medium leading to increased cooling, particularly where it is in contact with the surface, or by initiating crystallization, for example by nucleation.

In the present case, the term “solidification” is intended to encompass the transition process in the aggregate state in which the polymer material changes from an at least partially liquid or viscous state to a solid state, in particular from the molten state to a solid state. The polymer material is completely solidified when it has become solid throughout its entire mass.

A “surface structuring” is preferably a three-dimensional structure of a surface or a surface topology produced by the use of treatment agents such as the liquid treatment medium. These include, for example, surface designs such as imitations of wood grain and stone or metal surfaces with a pattern that extends in the main plane of extension of the surface and has different depth ranges. The surface of the substrate can at the time of provision already have a surface structure, i.e. before treatment by means of the liquid treatment medium, for example a roughness or pattern caused by a previous manufacturing step.

An edge strip can, for example, be an extruded profile that is provided to improve the aesthetics of a piece of furniture or intended as a transition between a floor covering and a wall.

The edge strip has a base body and a near-surface layer. In this case, the near-surface layer can be a region of the base body so that the edge strip is solid and the surface that is treated by the method is a surface of the base body. The near-surface layer can also be a layer that differs from the base body in its material composition. Alternatively, the near-surface layer can have the same material composition as the base body but can be manufactured separately from the base body and later arranged on a surface of the base body or bonded to the base body.

Preferably, the near-surface layer has a thickness that is equal to or greater than the depth of the surface structuring. This allows the properties of the near-surface layer to be used for surface structuring, and the base body can be used, for example, as a more cost-effective carrier. Alternatively, or at least in some regions, the near-surface layer can have a thickness that is less than the depth of the surface structuring. The properties of not only the near-surface layer but also the base body arranged underneath it can thus contribute to the aesthetic and/or functional effect of the surface structuring.

The surface structuring of the edge strip has been produced by a method according to the present invention. Such a surface structuring has, for example, a repeat length that is greater than a repeat length of a surface treated by means of an embossing roller.

The individual embodiments of the method and of the edge strip described below can be combined with each other as desired. Furthermore, the method steps can be carried out in any order, preferably in the specified order.

In a first embodiment of the method, the polymer material on the surface of the substrate has already been cooled and solidified at least once, and the polymer material is converted into a molten state again to provide the substrate with a surface.

This allows substrates to be stored and/or transported as intermediate products after their production, as required, before their surface is treated. This also makes it possible to provide the substrate as an injection-molded part, wherein the substrate has been injected into a mold and has already been cooled at least once, for example by the mold itself.

The re-conversion into the molten state is preferably carried out by means of a method step prior to the application of the liquid treatment medium to the surface, in which the polymer material is heated on the surface of the substrate.

In a further embodiment of the method, the substrate is formed in one or more layers, in particular as a sandwich structure.

End products can thus be achieved with a character that is adapted with regard to cost savings and/or specific uses on the one hand, and on the other hand with a relatively high degree of design freedom with regard to the aesthetics and/or functionality of the surface.

In a further embodiment of the method, the substrate is provided in the form of a co-extruded edge strip with a near-surface layer and a base body, wherein the near-surface layer comprises a first polymer material with a first melt viscosity, and the base body comprises a second polymer material with a second melt viscosity, and wherein the first melt viscosity is lower than the second melt viscosity.

In a corresponding embodiment of the edge strip, the base body comprises a first polymer material, wherein the first polymer material contains a first thermoplastic and/or a first thermoplastic elastomer. Furthermore, the at least one near-surface layer has a second polymer material and is arranged on an outer side of the base body, wherein the second polymer material contains a second thermoplastic and/or a second thermoplastic elastomer, and the first polymer material and the second polymer material are different.

A substrate is thus provided with a base body and a near-surface layer that have different solidification temperatures. In other words, the substrate can be provided such that the base body is in a solid state and the near-surface layer is in a molten state. Accordingly, by applying the liquid treatment medium, the polymer material at the near-surface layer can be more easily displaced to create the surface structuring. In addition, changes in the properties of the base body, which can cause a transition to a molten state, can be avoided, wherein at the same time optimal conditions are created for the production of surface structuring on the near-surface layer.

In a further embodiment of the method, the substrate is provided as an extrudate, and the substrate is exposed to the liquid treatment medium before the start of a cooling step.

This allows substrates such as extruded profiles to be treated in an industrial manner. Furthermore, existing production lines can thus be supplemented or retrofitted by means of the method.

Preferably, the surface is exposed to the liquid treatment medium immediately upon exiting an extruder. The present method can thus be carried out following a manufacturing step of an extrusion method. As a result, the entire production time of, for example, an edge strip with surface structuring can be optimized.

The cooling step can be actively supported, for example by using a cooling or cooled roller, by applying a cooling mist, by quenching or similar. Alternatively or additionally, the cooling step can be carried out by storage in air.

In a further embodiment of the method, the substrate is provided as an injection-molded part produced by means of an injection-molding process, wherein the polymer material has been converted back into a molten state after the injection-molding process.

Injection molding is a commonly used method that makes it possible to produce large quantities within a short time. As a rule, a material in a liquid or viscous state is injected into a mold, wherein the material then cools in the mold and assumes the shape of the mold. With the method in the present embodiment, the surface of an injection-molded part produced in this way can be treated, and its surface can be given a surface structuring. Overall, this allows products to be manufactured on an industrial scale. At the same time, subsequent heating or subsequent re-conversion of the surface into the molten state allows increased flexibility in logistics since the injection-molded part can be stored, transported or the like before surface treatment with the liquid treatment medium without these intermediate steps having an influence on the quality of the surface structuring.

Preferably, the surface of the substrate or the polymer material is converted into a molten state by heating. Heating can be effected by means of heat lamps, radiant heaters and/or lasers.

In a further embodiment of the method, the surface of the substrate is exposed to the liquid treatment medium according to a predetermined spatial pattern such that the surface structuring corresponds to the spatial pattern.

By specification of a desired pattern in advance, a surface structuring can be reproduced from one substrate to another, which increases the repeatability of the method and the reliability of the method result. In addition, a pattern can be planned and designed as desired to give the surface of the substrate an appropriate aesthetic and/or functionality.

A spatial pattern is understood to mean a three-dimensional surface topology that gives the surface a certain aesthetic and/or a certain functionality, in particular one that the surface would not have without treatment. Examples of such aesthetics are an imitation of a wood grain, a stone or metal surface, a matte or glossy effect, a coloring, a smoothing, etc. Examples of surface functionalization are a change in scratch resistance, an increase or decrease in permeability to gases or liquids, a change in resistance to environmental influences, a change in surface tension or surface hardness, an antimicrobial effect, a self-cleaning effect, a change in sliding properties or wetting behavior.

The liquid treatment medium can be pressurized and applied to the surface with the aid of a nozzle, a print head and/or through a mask to create the prespecified spatial pattern on the surface.

In a further embodiment of the method, for application, the liquid treatment medium is accelerated in the direction of the surface of the substrate depending on a desired penetration depth into the polymer material of the surface of the substrate.

This allows adjustment of the depth the surface structuring should have. Such depth is particularly relevant, for example, in the case of an imitation of a wood look or when it is desired to give the surface a special feel. Surface functionalization can also depend strongly on the relief of the surface.

In particular, the acceleration of the liquid treatment medium can be adjusted by setting a pressure under which the liquid treatment medium is placed to act on the surfaces.

The acceleration of the liquid treatment medium in the direction of the surface preferably causes a material displacement, in particular a displacement of the polymer material in the molten state, which creates a relief and therefore a surface structuring over the exposed surface. The target penetration depth then corresponds to a desired intensity of the material displacement caused in this way.

In a further embodiment of the method, the liquid treatment medium is provided with properties that have been selected depending on at least one property of the polymer material.

In this way, the liquid treatment medium can be tailored to the surface to be treated. This opens up expanded fields of application for the method by allowing substrates of different compositions, especially with polymer materials of different types, to be treated. With the method, surface structuring of different types can then be achieved, whether with a special look, feel or functionality.

Examples of polymer material properties include: substrate preparation temperature, melt viscosity, thermal conductivity, heat capacity, scratch resistance, elastic modulus, plastic modulus, hardness, flowability, microstructure, nanostructure, polymer chain arrangement, crystalline arrangement, color, light transmittance, light reflectance, surface tension, electrical charge, polarity, permittivity, electrical conductivity, surface roughness, chemical resistance, pH value, and more. For a polymer material that contains at least two different polymer materials, the liquid treatment medium can be selected taking into account at least one property of each of the polymer materials.

Examples of properties of the liquid treatment medium are: quantity, temperature during application of the liquid treatment medium to the surface, boiling point, thermal conductivity, heat capacity, flowability, microstructure, nanostructure, polymer chain arrangement, color, light transmittance, light reflectance, surface tension, electrical charge, polarity, permittivity, electrical conductivity, density, viscosity, thixotropy and others. For example, the viscosity or thixotropy of the treatment medium can have an influence on its flow behavior on the surface to be treated.

For example, it can be provided that the treatment medium and the surface have temperatures selected in such a way that the treatment medium evaporates after being applied to the surface.

Various treatment media can be used for the method. The treatment medium is preferably selected according to the desired properties of the edge strip or of the surface structuring to be created. Preferably, the treatment medium is selected from the group consisting of water, nucleating agent; dye; UV pigment; microbicide; gloss control agent; matting agent, and mixtures thereof.

In a further embodiment of the method, the liquid treatment medium contains at least one nucleating agent.

By a nucleating agent being applied to the surface, the number of nucleation nuclei that arise at the beginning of a crystallization method in polymer materials is increased, at least locally. This can make it possible, for example, to achieve structuring in polymers that have a different volume in the crystalline state than in the amorphous state. Furthermore, the mechanical properties of the polymer material can be improved and crystallization accelerated, which in turn makes possible an increase in cycle time during preparation.

Examples of nucleating agents are: dibenzylidene sorbitol (DBS), bis(p-methyldibenzylidene sorbitol) (MDBS), bis(p-ethyldibenzylidene sorbitol) (DMDBS), sodium 2,2′-methylene-bis-(4,6-di-tert-butyl-phenyl) phosphate, aluminum hydroxy-bis(4-tert-butylbenzoate), N,N′-dicyclohexyl-2-6-naphthalenedicarboxamide, 4-biphenylcarboxylic acid, thymine, talc, sodium benzoate.

In a further embodiment of the method, the liquid treatment medium contains at least one additive, in particular an additive from the list: dye; UV pigment; microbicide; gloss control agent; matting agent.

This allows several effects to be achieved simultaneously, for example improved mechanical and optical properties of the polymer material on the treated surface.

In a further embodiment of the method, the polymer material of the substrate has been selected with respect to its melt viscosity.

By selecting a suitable melt viscosity of the polymer material, optimal material displacement effects can be achieved by applying the liquid treatment medium. In particular, optimal surface structuring can be achieved by selecting both the polymer material on the basis of its melt viscosity as well as the liquid treatment medium on the basis of this melt viscosity.

In a further embodiment of the method, the surface of the substrate is exposed to two or more portions of the treatment medium, wherein the portions of the treatment medium have different temperatures. Alternatively, the surface of the substrate is exposed to at least a first and a second treatment medium.

Due to the different temperatures, a heterogeneous surface structuring can be achieved. An example of this is a surface structuring with matte regions and shiny regions. Another example is surface structuring with different depths, because the degree of material displacement depends, among other things, on the temperature difference between the temperature of the exposed surface and the temperature of the liquid treatment medium.

The portions of liquid treatment medium can have the same composition, but can each be placed in containers separate from each other at a prespecified temperature before being applied to the surface simultaneously or with a time delay relative to each other.

The at least two liquid treatment media can differ, for example, in their composition or physical state and can be applied to the surface simultaneously or with a time delay relative to each other.

Alternatively or additionally, at least a first and a second treatment medium can be provided and applied to the surface, wherein the first treatment medium and the second treatment medium have different polarities, solubilities and/or surface tensions.

In a further embodiment of the method, the surface of the substrate is exposed to the liquid treatment medium by means of an ink-jet process.

By means of inkjets, locally limited surface regions of the surface to be treated can be exposed and therefore structured. In addition to the local positioning of the applied droplets of the treatment medium, their volume and acceleration can also be controlled very precisely. Droplets can also be applied to the same area multiple times to achieve desired effects or to take into account the properties of the respective substrate.

In a further embodiment of the method, the surface of the substrate is exposed to the liquid treatment medium by means of an airbrush process.

In a further embodiment of the method, the surface of the substrate is exposed to the liquid treatment medium by means of high-speed rotary atomization.

This means that comparatively larger surface areas can be treated in one go.

In general, these embodiments offer the advantage that already available means can be used or adapted to carry out the method.

In a further embodiment of the method, after the surface of the substrate has been exposed to the liquid treatment medium, the exposed surface of the substrate is post-treated, in particular in a cooling step and/or in a fixing step.

This allows the surface structuring to be permanently established or made more resistant. Furthermore, the surface having the surface structuring can be treated with a further agent, such as a lacquer, a resin or a primer, in order to create an additional layer on the surface structuring, and/or can be subjected to a plasma treatment.

In a further embodiment of the edge strip, a first near-surface layer is provided on a first side of the base body, and a second near-surface layer is provided on a second side of the base body facing opposite the first side of the base body. In addition, the first near-surface layer has a first surface structuring, and the second near-surface layer comprises a second surface structuring, wherein the first surface structuring and the second surface structuring have both been produced by a method as described above.

This makes it possible to provide an edge strip that has a surface structuring on two sides. In this case, the first surface structuring and the second surface structuring can be different.

In a further embodiment of the edge strip, the first surface structuring and the second surface structuring have different visual patterns and/or different surface properties.

Such an edge strip can be adapted to its intended, later use, for example in the field of furniture production. In addition, this can eliminate the need for additional method steps for surface treatment.

Further features and advantages of the method and of the edge strip will become apparent from the following description of embodiments, wherein reference is made to the attached drawing.

### BRIEF DESCRIPTION OF THE DRAWINGS

FIG. 1 is a flowchart for a first exemplary embodiment of a method for treating a surface;

FIG. 2 is a schematic representation of another exemplary embodiment of a method for treating a surface;

FIG. 3 is a schematic representation of another exemplary embodiment of a method for treating a surface;

FIG. 4 is a schematic representation of another exemplary embodiment of a method for treating a surface;

FIG. 5 is a schematic representation of a substrate whose surface has been treated; and

FIG. 6 is an exemplary embodiment of an edge strip in a sectional view.

### DETAILED DESCRIPTION

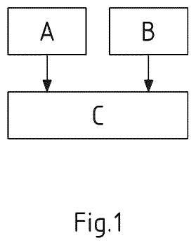

FIG. 1 shows a flow chart for a first embodiment of a method for treating a surface. In a first step A, a substrate with a surface is provided, wherein the surface contains a thermoplastic. In step A, the thermoplastic has a temperature that lies above its melting temperature and is in a molten state.

Step B, in which a liquid treatment medium in the form of water droplets is provided, takes place parallel to step A.

The parallel steps A and B are followed by step C, in which the surface of the substrate is exposed to droplets of the liquid treatment medium according to a prespecified pattern. Due to the presence of the droplets on the surface and the molten state of the thermoplastic when exposed to the liquid, a material change takes place on the surface during the subsequent cooling. This material change results in a surface structuring corresponding to the pattern according to which the droplets were directed towards the surface.

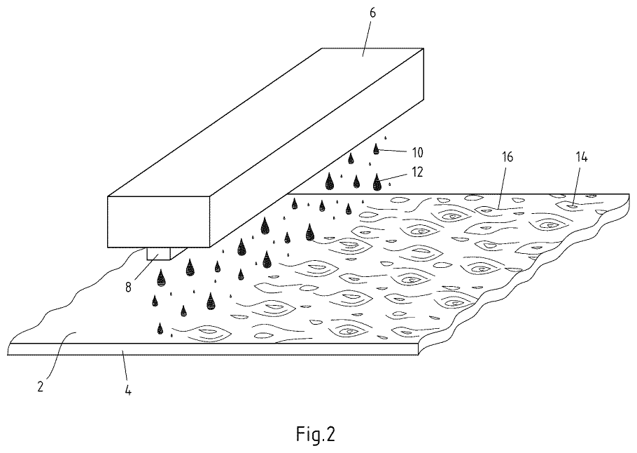

FIG. 2 shows a schematic representation of another exemplary embodiment of a method for treating a surface 2. Shown is a film 4 with a surface 2 that has a thermoplastic elastomer. The film 4 moves from left to right and is exposed to an application module 6. The application module 6 has an inkjet head 8 and is arranged above the surface 2 of the film 4. The application module 6 applies a treatment agent 10 as droplets 12 to the surface 2 moving underneath. After the application, i.e. to the right of the application module 6 in FIG. 2, the surface 2 of the film 4 has a surface structuring 14 with regions 16 which are the result of a material displacement.

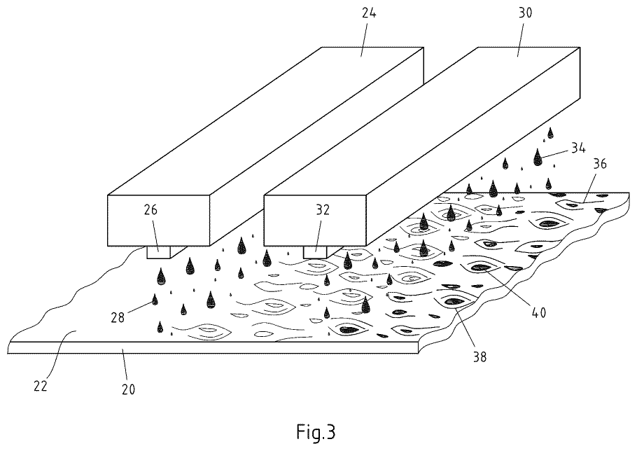

FIG. 3 shows a schematic representation of a further exemplary embodiment of a method for treating a surface 22. This method is based on the method described with reference to FIG. 2 with an additional application step. Accordingly, FIG. 3 also shows a film 20 with a surface 22 that moves from left to right, as well as a first application module 24 with a first inkjet head 26 and a first treatment medium 28. In addition, and in contrast to the embodiment in FIG. 2, a second application module 30 with a second ink-jet head 32 is provided, which is arranged above the film 20 and after the first application module 24 in the direction of movement of the film 20. The second application module 30 applies to the surface 22 of the film 20 a second treatment medium 34 that contains a gloss control agent. After the successive application, i.e. on the right in FIG. 3, the surface 22 of the film 20 has a surface structuring 36. This has regions 38 that are the result of material displacement and matte regions 40.

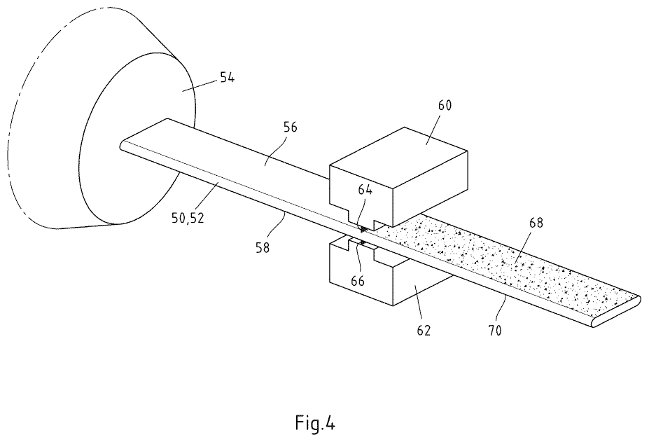

FIG. 4 shows a schematic representation of a further exemplary embodiment of a method for treating a surface. A substrate 50 in the form of an extruded profile 52 exiting an extruder 54 is provided. The substrate 50 has a first surface 56 and a second surface 58 each of which has a thermoplastic that is still in a molten state from the manufacturing process by means of the extruder 54. In the direction of movement of the extruded profile 52, a first application module 60 and a second application module 62 are provided. The first application module 60 is directed towards the first surface 56, and the second application module 62 is directed towards the second surface 58.

With the first application module 60, a first liquid treatment medium 64 is applied to the first surface 56 and with the second application module 62 a second liquid treatment medium 66 is applied to the second surface 58.

After the double-sided application, the substrate 50 or the extruded profile 52 has a first surface structuring 68 with an antimicrobial effect on the first surface 56 and a second surface structuring 70 with an increased Vickers hardness on the second surface 58.

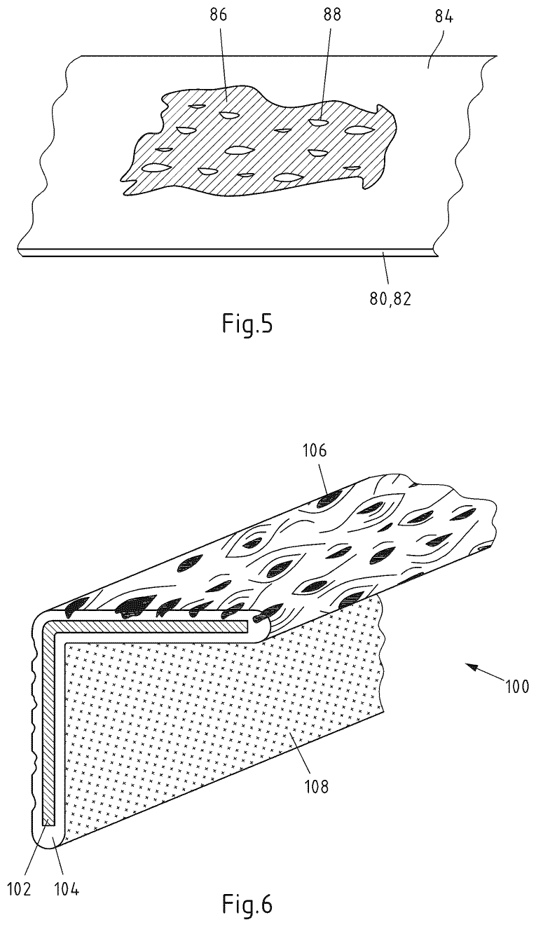

FIG. 5 shows a schematic representation of a substrate 80 in the form of a film 82, the surface 84 of which has been treated by exposure to a liquid treatment medium. The surface 84 has matte regions 86 and shiny regions 88 that form a spot pattern.

FIG. 6 shows an exemplary embodiment of an edge strip 100 in a sectional view. The edge strip 100 has a base body 102 with a first polymer material and a near-surface layer 104, which partially surrounds the base body 102, with a second polymer material. The first polymer material has a higher strength than the second polymer material and serves as a carrier material for the decorative or functional near-surface layer 104.

Regions of the near-surface layer 104, which are arranged on the outer sides of the base body 102, have a first surface structuring 106 which is an imitation of a wood grain. Furthermore, regions of the near-surface layer 104, which are arranged on the inner sides of the base body 102, have a second surface structuring 108 with a comparatively increased surface roughness. The second surface structuring 108 ensures that when a plurality of edge strips 100 are stacked on top of each other, they do not block each other.

1. A method for treating a surface, the method comprising the steps of:
providing a substrate (4, 20, 50, 80) with the surface, wherein the surface at least partially comprising a polymer material, wherein the polymer material contains a thermoplastic elastomer, a thermoplastic elastomer, or both, and wherein the polymer material on the surface of the substrate is at least partially in a molten state;
providing a liquid treatment medium in the form of droplets; and
accelerating the liquid treatment medium towards the surface of the substrate;
wherein the surface of the substrate is exposed to the liquid treatment medium before the polymer material has completely solidified, preferably so that a surface structuring is produced on the surface of the substrate.

2. The method according to claim 1, wherein the polymer material on the surface of the substrate has already been cooled and solidified at least once; and
wherein during the step of providing the substrate with the surface the polymer material is again converted into a molten state.

3. The method according to claim 1, wherein the substrate is formed in one or more layers, in particular as a sandwich structure.

4. The method according to claim 1, wherein the substrate is provided in the form of a co-extruded edge strip with a near-surface layer and a base body, wherein the near-surface layer comprises a first polymer material with a first melt viscosity, and the base body comprises a second polymer material with a second melt viscosity, and wherein the first melt viscosity is lower than the second melt viscosity.

5. The method according to claim 1, wherein the substrate is provided as an extrudate, and
wherein the substrate is exposed to the liquid treatment medium before the start of a cooling step.

6. The method according to claim 1, wherein the substrate is provided as an injection-molded part produced by an injection-molding process, and
wherein the polymer material has been converted back into a molten state after the injection-molding process.

7. The method according to claim 1, wherein the surface of the substrate is exposed to the liquid treatment medium according to a prespecified spatial pattern such that the surface structuring corresponds to the spatial pattern.

8. The method according to claim 1, wherein the liquid treatment medium is accelerated in the direction of the surface of the substrate depending on a desired penetration depth into the polymer material of the surface of the substrate.

9. The method according to claim 1, wherein the liquid treatment medium is provided with properties which have been selected depending on at least one property of the polymer material.

10. The method according to claim 1, wherein the liquid treatment medium contains at least one nucleating agent.

11. The method according to claim 1, wherein the liquid treatment medium contains at least one additive, in particular an additive from the list: dye; UV pigment;
microbicide; gloss control agent; matting agent.

12. The method according to claim wherein the polymer material of the substrate has been selected with respect to its melt viscosity.

13. The method according to claim 1, wherein the surface of the substrate is exposed to either:
two or more portions of the treatment medium, wherein the portions of the treatment medium have different temperatures, or at least
a first and a second treatment medium.

14. The method according to claim 1, wherein the surface of the substrate is exposed to the liquid treatment medium by an ink-jet process.

15. The method according to claim 1, wherein the surface of the substrate is exposed to the liquid treatment medium by an airbrush process.

16. The method according to claim 1, wherein the surface of the substrate is exposed to the liquid treatment medium by high-speed rotation atomization.

17. The method according to claim 1, wherein after the surface of the substrate has been exposed to the liquid treatment medium, the exposed surface of the substrate is post-treated, in particular in a cooling step, and/or in a fixing step, or both.

18. (canceled)

19. (canceled)

20. (canceled)

21. (canceled)

22. The method according to claim 1, wherein the polymer material is selected from the group consisting of polyethylene, polypropylene, acrylonitrile-butadiene-styrene copolymer, polyvinyl chloride, polymethyl methacrylate, polyethylene terephthalate, polylactic acid, thermoplastic styrene elastomers (TPS), thermoplastic urethane elastomers (TPU), thermoplastic polyamide elastomers (TPA), thermoplastic copolyester elastomers (TPC), thermoplastic olefin elastomers (TPO), thermoplastic vulcanizates (TPV), and mixtures thereof.

23. The method according to claim 1, wherein the polymer material on the surface of the substrate which is in a molten state has a temperature which exceeds the melting temperature of the polymer material, in particular a temperature which exceeds the melting temperature of the polymer material by at least 15° C.

24. The method according to claim 1, wherein the substrate is a solid component.

25. The method according to claim 1, wherein the substrate is a film, an intermediate product or component for the manufacture of furniture, floors, automobiles or windows.

26. The method according to claim 1, wherein the substrate is provided as an extrudate by being produced by post-co-extrusion, wherein a base body is produced by a first extruder, and then a surface layer is applied to the base body by a further extruder downstream of the first extruder, and wherein the base body is at least partially solidified when the surface layer is applied as a melt stream, and
wherein the substrate is exposed to the liquid treatment medium before the start of a cooling step.

27. The method according to claim 1, wherein the surface structuring corresponds to an imitation of a wood grain, of stone, or metal surfaces with a pattern that extends in the main extension plane of the surface of the substrate and has different depth ranges.

28. The method according to claim 1, wherein the surface of the substrate as it is provided already has a surface structure, in particular a roughness or pattern caused by a preceding manufacturing step.

29. The method according to claim wherein the surface structuring corresponds to a surface functionalization, wherein the surface functionalization has an effect from the list of: a change in scratch resistance, an increase or decrease in permeability to gases or liquids, a change in resistance to environmental influences, a change in surface tension or surface hardness, an antimicrobial effect, a self-cleaning effect, a change in sliding properties or wetting behavior.

30. The method according to claim 1, wherein the liquid treatment medium contains at least one nucleating agent, wherein the at least one nucleating agent is one from the list of: dibenzylidene sorbitol (DBS), bis(p-methyldibenzylidene sorbitol) (MDBS), bis(p-ethyldibenzylidene sorbitol) (DMDBS), sodium 2,2′-methylene bis(4,6-di-tert-butylphenyl) phosphate, aluminum hydroxy bis(4-tert-butylbenzoate), N,N′-dicyclohexyl-2-6-naphthalenedicarboxamide, 4-biphenylcarboxylic acid, thymine, talc, sodium benzoate.

31. The method according to claim 1, wherein the treatment medium and the surface of the substrate have temperatures selected such that the treatment medium evaporates after being applied to the surface.

32. The method according to claim 1, wherein the surface of the substrate is exposed to at least a first and a second treatment medium, wherein the at least two liquid treatment media differ in their composition or physical state and are applied to the surface simultaneously or with a time delay relative to one another.

33. The method according to claim 1, wherein at least a first and a second treatment medium are provided and applied to the surface, wherein the first treatment medium and the second treatment medium differ based on one or more of the following properties: polarity, solubility, surface tension.
